(19) United States
(12) Patent Application Publication
(10) Pub. No.: US 2025/0178000 A1
(43) Pub. Date: Jun. 5, 2025

(54) CONTINUOUS FLOW CENTRIFUGE

(71) Applicant: Sartorius Stedim North America Inc., Bohemia, NY (US)

(72) Inventor: Eckhard Tödteberg, Osterode (DE)

(73) Assignee: Sartorius Stedim North America Inc., Bohemia, NY (US)

(21) Appl. No.: 19/047,345

(22) Filed: Feb. 6, 2025

Related U.S. Application Data
(63) Continuation of application No. PCT/EP2023/071664, filed on Aug. 4, 2023.

(30) Foreign Application Priority Data
Aug. 9, 2022 (EP) 22 189 564.2

(51) Int. Cl. B04B 11/02; B04B 15/02

(52) U.S. Cl. CPC B04B 11/02; B04B 15/02

(57) ABSTRACT

The invention relates to a continuous flow centrifuge with a rotor. The continuous flow centrifuge comprises a connecting section with connection conduits. Via the connection conduits an exchange of media in receptacles arranged in centrifugation chambers of the rotor is possible. A temperature control supply conduit and temperature control discharge conduit for a connecting section temperature control fluid both extend through the connecting section in order to counteract heating of the connecting section as a result of the flexing work and friction occurring therein. The connecting section temperature control fluid flows through the temperature control supply conduit and the temperature control discharge conduit in opposite flow directions. An electronic control unit (28) comprises control logic which controls (open loop or closed loop) the connecting section temperature control circuit.

### CROSS REFERENCE TO RELATED APPLICATIONS

This application is a continuation of International Application No. PCT/EP2023/071664 with an international filing date of Aug. 4, 2023, and claiming priority to co-pending European Patent Application No. EP 22 189 564.2 entitled “Durchflusszentrifuge,” filed on Aug. 9, 2022, the disclosures of which are hereby incorporated herein by reference in their entirety.

### FIELD OF THE INVENTION

The invention relates to a continuous flow centrifuge in which at least one medium (in particular a fluid, a liquid, a suspension, etc.) is supplied at least temporarily to a centrifugation chamber and/or a medium is discharged from the centrifugation chamber while the centrifugation chamber is rotating. The medium can be arranged in a receptacle in the centrifugation chamber. The at least one medium is, in particular, the medium to be centrifuged, a rinsing liquid, a washing solution or buffer solution, a modified medium extracted from the centrifuged medium and/or a sediment in the centrifugation chamber.

To give only a few non-limiting examples of the invention, the continuous flow centrifuge may be a blood centrifuge in which the medium to be centrifuged is blood and the extracted modified medium or sediment are blood cells or particles, or a continuous flow centrifuge by means of which cells, microcarriers or other particles contained in the medium are to be extracted from a medium. It is also possible that the centrifuged medium is not a pure liquid, but rather a solution or suspension with particles such as cells, cell debris or cell parts etc.

The continuous flow centrifuge is used, for example, for the production of biopharmaceutical products in biopharmaceutical companies or in bioprocessing applications. The continuous flow centrifuge can be used, for example, to obtain and/or clarify cells or microcarriers. The cells obtained in this way can also be used for the cell therapy. Another field of application for the continuous flow centrifuge is, for example, the production of vaccines.

### BACKGROUND OF THE INVENTION

Continuous flow centrifuges of this type are marketed, for example, by the company Sartorius AG, Otto-Brenner-Straße 20, 37079 Göttingen, Germany, and affiliated companies under the marking “Ksep” (registered trademark). On the website relating to these continuous flow centrifuges

www.sartorius.com/en/products/process-filtration/cell-harvesting/ksep-systems

(Date of inspection: 07.06.2022)

the operating principle of a continuous flow centrifuge, as it can also be used for the present invention, is described as follows on the basis of a linked video:

A rotor of the continuous flow centrifuge comprises four centrifugation chambers, which can be embodied as blood bags held on a rotor body and are evenly distributed around the circumference. The centrifugation chambers are arranged at equal radial distances from the rotational axis of the rotor. A first connection conduit opens radially inwards into a centrifugation chamber, while a second connection conduit opens radially outwards into the centrifugation chamber. In a first operating phase, a first medium embodied as blood, for example, is fed to the centrifugation chamber via the second connection conduit while the centrifugation chamber rotates with the rotor. In the centrifugation chamber, particles contained in the blood (e.g. blood bodies) are deposited radially on the outside as a result of the centrifugation, while the residual medium (i.e. the medium supplied radially on the outside reduced by the particles pushed radially outwards) is discharged from the centrifugation chamber radially on the inside via the first connection conduit. In this first operating phase, the first connection conduit is therefore a discharge conduit, while the second connection conduit is a supply conduit. As this operation continues, the proportion of particles and their concentration in the centrifugation chamber increases until the chamber is largely and finally completely filled with particles. In a subsequent optional second operating phase, the particles are washed in the centrifugation chamber. For this purpose, a washing or buffer solution is supplied to the centrifugation chamber via the second connection conduit. The washing or buffer solution rinses through the centrifugation chamber and is discharged radially inwards via the first connection conduit. In this operating phase, the centrifugation chamber also rotates with the rotor so that the particles are prevented from exiting the centrifugation chamber with the washing or buffer solution via the first connection conduit as a result of the centrifugation force. Also during the second operating phase the first connection conduit serves as a discharge conduit for the washing or buffer solution, while the second connection conduit serves as a supply conduit for the washing or buffer solution. In a subsequent third operating phase, the centrifugation chamber continues to rotate with the rotor. In the third operating phase, the direction of flow through the centrifugation chamber is reversed and the particles are removed from the centrifugation chamber via the second connection conduit, while wash or buffer solution can be fed into the centrifugation chamber via the first connection conduit. The third operating phase ends when all the particles have been removed from the centrifugation chamber. This can be followed by successive further cycles with the three operating phases described above.

EP 3 936 601 A1 (corresponding to US patent application US 2023/0250384 A1) shows the design of a medium network which is connected to the connection conduits and ensures the different operating phases. With regard to this medium network, the pump arrangement contained therein, the process control unit, an additional filter arrangement, receptacles for the different media and with regard to the process sequence, additional reference is made to EP 3 936 601 A1, EP 2 310 486 B1 (corresponding to U.S. Pat. No. 9,090,910 B2, U.S. Pat. No. 9,279,133 B2 and U.S. Pat. No. 10,208,283 B2) and EP 2 485 846 B1.

EP 2 485 846 B1 (corresponding to U.S. Pat. No. 9,839,920 B2 and U.S. Pat. No. 10,888,878 B2) describes that in continuous flow centrifuges, fluidic connections to connection conduits rotating with the rotor by means of rotary feedthroughs are problematic, as the rotary feedthroughs are susceptible to leaks and entail the risk of unwanted contamination of the media. On the other hand, it is explained that, according to U.S. Pat. Nos. 4,216,770, 4,419,089, 4,389,206 and 5,665,048, connecting sections are used into which the connection conduits can be integrated. One end region of the connecting section is fixed to the housing, while the other end region of the connecting section is attached to the rotor and is twisted with the rotor. In order to prevent the twisting of the connecting section from increasing as a result of the rotation of the rotor and the relative rotation of the end regions of the connecting section, the connecting section is also guided in a guiding device embodied as a guiding tube. The guiding tube has a section comprising the shape of a rounded U with side legs of different lengths that are slightly spread apart. The opening of the U points in the direction of the rotor's axis of rotation. Starting from the end region fixed to the housing, the connecting section curves outwards and enters a side leg of the U. In the U-shaped section, the connecting section is guided around the rotor by the guiding tube. The free end region of the other side leg of the U of the guide tube is curved back so that it is arranged coaxially to the axis of rotation of the rotor and immediately adjacent to the entry of the connecting section into the rotor. The guiding tube is then driven at half the speed of the rotor. EP 2 485 846 B1 refers to U.S. Pat. No. 3,586,413 for an explanation of how to avoid increasing twisting of the connecting section by using the rotating guiding tube.

WO 80/02653 A1 discloses a blood pump by means of which blood can be taken from a patient, the blood is separated into red blood cells and blood plasma and then the red blood cells are returned to the patient while the blood plasma is collected. The separation takes place in a centrifugation process due to the different densities. WO 80/02653 A1 describes that the supply of blood via a rotary coupling to a rotating separation chamber is problematic, as undesirable heat is generated in the area of the rotary coupling, which impairs the blood and its components or requires additional cooling. Furthermore, it is considered problematic that the blood particles can be damaged as a result of shear forces in the area of the contact surfaces between the coupling parts of the rotary coupling. The blood pump proposed in WO 80/02653 A1 has a connecting section through which several conduits extend. Blood supply conduits extend from a first end of the connecting section through the connecting section to separation chambers of the connecting section arranged in the other end region, and blood discharge conduits extend in the opposite direction from the separation chambers to the first end of the connecting section. The first end of the connecting section extends vertically and is held rigidly on a machine frame element. Blood passes from the patient to the first end region and, after separation, the blood cells pass from the first end region back to the patient. A carousel is rotatable about an axis of rotation that extends vertically and coaxially with the first end region of the connecting section. In the carousel, the connecting section is firmly clamped adjacent to the first end region and coaxial to the axis of rotation. From this fixed clamping, the connecting section extends radially outwards along a quarter-circle arc through the carousel in such a way that the second end region of the connecting section with the separation chambers formed therein is oriented horizontally and comprises the greatest distance from the axis of rotation. The second end region is clamped in the carousel in such a way that the orientation of the second end region is defined. The connecting section runs freely between the clamps in the two end regions. The rotation of the connecting section about the axis of rotation is accompanied by a rotational movement of the connecting section in the second end region around the horizontal clamping axis to enable a compensating movement. A cooling liquid can be arranged in a conduit of the connecting section, by means of which heat can be absorbed, which is generated by a shear stress on the connecting section as a result of the bending of the same during rotation.

The publications DE 26 12 988 A1 (corresponding to U.S. Pat. Nos. 4,056,224 A and 4,113,173 A), DE 35 04 205 A1 (corresponding to U.S. Pat. No. 4,648,863 A) and U.S. Pat. No. 3,129,174 A describe continuous flow centrifuges comprising a rotor with a centrifugation chamber and a connecting section guided in a guiding device, whereby the guiding device is rotated at half the rotor speed of the rotor to prevent twisting of the connecting section.

### SUMMARY OF THE INVENTION

With the new invention it is possible to improve a continuous flow centrifuge with regard to ensuring performance under predetermined operating conditions.

The continuous flow centrifuge comprises a rotor which has (at least) one centrifugation chamber. The medium to be centrifuged can be arranged in the centrifugation chamber directly or in a suitable receptacle. The centrifugation chamber can be flushed with other media such as a washing or buffer solution. In the continuous flow centrifuge, the rotor is rotated about the rotor axis at a rotor speed. The continuous flow centrifuge has a connecting section (or connecting strand, in the following “connecting section”). The connecting section comprises a connection conduit via which a medium can be supplied to the centrifugation chamber (in particular to a receptacle arranged in the centrifugation chamber) during operation of the continuous flow centrifuge when the rotor rotates. Furthermore, the connecting section comprises a connection conduit via which a medium can be discharged from the centrifugation chamber (in particular from a receptacle arranged in the centrifugation chamber). Depending on the operating phase, the flow directions through the connection conduits can be reversed. One end region of the connecting section is fixed to the housing, while the other end region of the connecting section is rotated with the rotor. In order to avoid twisting of the connecting section, the connecting section is guided in a guiding device, in particular a guiding tube. The guiding device is rotated about the rotor axis at half the rotor speed. In this respect, the continuous flow centrifuge can, for example, be embodied as the prior art flow centrifuges mentioned at the beginning.

In a continuous flow centrifuge, the centrifugation of the medium in the centrifugation chamber and the supply and discharge of the media should take place under defined operating conditions as far as possible, which means that the temperature of the medium to be centrifuged is kept within a predefined temperature range. For this reason, rotor chamber temperature control circuits are used in continuous flow centrifuges. The rotor chamber temperature control circuit usually comprises a rotor chamber temperature control loop integrated into a wall of a vessel of the continuous flow centrifuge, which is in heat exchange with the rotor chamber in which the rotor is rotated. A temperature sensor, which may in some cases also be integrated into the vessel of the rotor chamber, senses the temperature in the rotor chamber. Based on the signal from the temperature sensor, the temperature control power or capacity (in the following “power”, covering both cooling power and heating power) of the rotor chamber temperature control circuit can then be controlled in such a way that the temperature in the rotor chamber is kept as constant as possible. According to the state of the art, it is assumed that the medium to be centrifuged also comprises a constant temperature.

Present considerations initially consider the causes of a change in temperature in a continuous flow centrifuge. One cause of heating of the interior space of the rotor chamber is that the air arranged in the rotor chamber is accelerated and swirled as a result of the rotational movement of the rotor, which can lead to heating of the air. Furthermore, heat can be introduced into the rotor chamber, for example, by a centrifuge drive or as a result of friction, for example in the bearings of a rotor shaft. This heating can be counteracted by means of the known rotor chamber temperature control circuit.

As a further cause of heat input, it has been recognized on the basis of the present considerations that the connecting section is deformed as a result of its boundary conditions, namely the fixed connection of one end region to the housing, the rotation of the other end region with the rotor and the guidance of the connecting section by means of the guiding device, which is rotated about the rotor axis at half the rotor speed. This deformation in particular leads to flexing of the connecting section, which leads to heating of the connecting section. Furthermore, the friction of the connecting section with the guiding device can lead to heating of the connecting section.

Conventional continuous flow centrifuges do not take into account the different possibilities for heat input, so that the different possibilities for heat input are only averaged and are commonly taken into account by the rotor chamber temperature control circuit. Even if, ideally, the known control by the rotor chamber temperature control circuit leads to a predetermined temperature of the temperature sensor in the wall of the vessel, local deviations in temperature can still occur. Preferably, an undesirably high temperature results in the area of the connecting section as a result of the flexing work and friction that occurs. If the media then flow through the connection conduits in the connection section, the media will heat up undesirably.

Based on this finding, it is proposed that a temperature control supply conduit and a temperature control discharge conduit extend through the connecting section in the continuous flow centrifuge. A connecting section temperature control fluid flows in opposite flow directions through the temperature control supply conduit and the temperature control discharge conduit. The temperature control supply conduit and the temperature control discharge conduit are thus in particular part of a connecting section temperature control circuit, via which cooling can be brought about specifically in the area of the connecting section, which ideally compensates for the heat generated as a result of the flexing work and friction in the area of the connecting section. Thus, a temperature increase can be counteracted directly at the point where it occurs. As a result, the operating conditions, in this case the temperature, can be maintained exactly or within predetermined temperature ranges in the continuous flow centrifuge, namely in the area of the connecting section.

In one embodiment, the continuous flow centrifuge comprises at least one electronic control unit. In the case of several electronic control units, the control units can be interconnected or networked. The electronic control unit comprises control logic by means of which the connecting section temperature control circuit is controlled (open loop or closed loop).

The temperature control supply conduit, the temperature control discharge conduit and the connection conduits (as well as any other components of the connecting section) can be arranged as desired across the cross-section of the connecting section, for example next to each other or one above the other. In one embodiment, the temperature control supply conduit, the temperature control discharge conduit and the connection conduits are arranged distributed in the circumferential direction around a longitudinal axis of the connecting section in a cross-section of the connecting section, preferably the conduits directly contacting an adjacent conduit when viewed in the circumferential direction.

The order in which the aforementioned conduits are arranged in the circumferential direction is basically arbitrary. In one embodiment, the temperature control supply conduit, the temperature control discharge conduit and the connection conduits are arranged in a cross-section of the connecting section distributed in the circumferential direction around the longitudinal axis of the connecting section in such a way that at least one connection conduit is arranged in each of the two circumferential directions around the longitudinal axis between the temperature control supply conduit and the temperature control discharge conduit. This means that the at least one connection conduit is arranged “sandwich-like” between the temperature control supply conduit and the temperature control discharge conduit, so that the at least one connection conduit is in heat exchange with both the temperature control supply conduit and the temperature control discharge conduit. This enables a particularly good heat transfer between the temperature control conduits and the connection conduits.

Preferably, the temperature control supply conduit and the temperature control discharge conduit in the continuous flow centrifuge are connected to each other via a reversing connection. In this case, the reversing connection can be embodied as a U-shaped connecting piece. In this case, one leg of the U can be connected to an end region of the temperature control supply conduit, while the other leg of the U can be connected to the end region of the temperature control discharge conduit. These connections can be made, for example, by inserting the respective leg into the temperature control conduit and securing it in the temperature control conduit (for example by a positive and/or frictional connection or clamping; in some cases also with the interposition of a seal or a sealant). It is also possible that the temperature control conduit and the leg of the connecting piece are plastically pressed with each other. The reversing connection is preferably connected in the end regions of the connecting conduit and of the temperature control conduits that is rotated with the rotor. The reversing connection ensures the opposite flows through the temperature control conduits.

According to one proposal, the connecting section comprises a flexible tube or a flexible hose. In this case, the temperature control supply conduit, the temperature control discharge conduit and the connection conduits extend through the flexible tube or hose. The tube or hose can have a smooth outer surface to minimize turbulence in the rotor chamber. Non-smooth outer geometries of the tube or hose are also possible. A flexible corrugated tube can also be used, for example. The flexible tube or hose keeps the temperature control conduits and connection conduits in a compact state and also ensures that the temperature control conduits and connection conduits are protected. It is also possible for the hose or tube to be used to thermally encapsulate the connecting section.

It is possible that the temperature control supply conduit and the temperature control discharge conduit only extend from the housing over a part of the longitudinal extension of the connecting section, this part of the longitudinal extension preferably coinciding with the area of the connecting section in which the previously explained flexing work and/or friction occurs. In this case, it is possible that the reversing connection is arranged at the end of the extension of the temperature control conduits, which leads to the result that the reversing connection or the U-shaped connecting piece is arranged inside the connection section, in particular inside the flexible tube or flexible hose. For another proposal, the reversing connection is arranged in the area of the temperature control supply conduit and the temperature control discharge conduit exiting from the flexible tube or hose, so that the temperature control conduits extend over the entire length of the connecting section. The arrangement of the reversing connection in the exiting area then utilizes a larger installation space available outside the tube or hose.

For a further proposal, the reversing connection is embodied as a U-shape. In this case, the U-shaped reversing connection can at least partially enclose at least one connection conduit. It is possible that the connection conduit is angled outwards at the exit from the tube or hose. In this case, the exiting area and the bend can be arranged at least partially inside the U of the U-shaped reversing connection, which makes it possible to provide additional guidance and/or protection and to define the position of at least one connection conduit. On the other hand, the partial enclosure of the connection conduit by the reversing connection results in a particularly compact design.

It is also possible that at least one electrical line extends through the connecting section in the continuous flow centrifuge. In this case, any heating of the connecting section and thus of the media in the connection conduits as a result of heating of the electrical line can also be avoided by controlling the connecting section temperature control circuit. To give only a few non-limiting examples, the electrical line can be any measuring line, an electrical supply line for a sensor arranged in the rotor or attached to the rotor, an electrical control line for a valve of the rotor, and the like.

In the continuous flow centrifuge, control (open loop or closed loop) in the connecting section temperature control circuit can take place in any way and can take into account any signals from temperature sensors, flow sensors and/or take into account any operating parameters of the continuous flow centrifuge (speed, external temperature, internal temperature, design and/or equipment of the rotor; centrifugation program and—parameters, . . . ). In one proposal, the temperature of the connecting section temperature control fluid and/or the flow (in particular the mass flow and/or volumetric flow) of the connecting section temperature control fluid is controlled (open loop or closed loop) taking into account a temperature of the medium which is located in and/or conveyed through at least one connection conduit. Preferably, the control (open loop or closed loop) takes into account a temperature difference in the connection conduits. If, for example, the temperature is measured in the outlet area of a connection conduit from which the medium is discharged from the centrifugation chamber and a temperature is measured in the inlet area of the other connection conduit that supplies the medium to the centrifugation chamber, the temperature difference provides information about the heat supplied to the medium between the two measuring points. With an increase in heat, a greater cooling power is required, which can be provided by controlling (open loop or closed loop) the temperature and/or flow of the connecting section temperature control fluid. For example, control (open loop or closed loop) can be carried out with the aim of ensuring that the temperature difference is zero or below a threshold value. At least one sensor for sensing the temperature or both sensors for detecting the temperature difference can also be arranged in the housing in the assigned end region of the connection conduit(s) and thus be stationary.

Preferably, the continuous flow centrifuge also has a rotor chamber temperature control circuit in addition to a connecting section temperature control circuit. Preferably, the rotor chamber temperature control circuit is arranged at a stationary fixed location, in particular with a cooling loop integrated into the wall of the vessel. It is possible that the connecting section temperature control circuit on the one hand and the rotor chamber temperature control circuit on the other are fluidically independent of each other, in which case the circuits can be coordinated via at least one control unit. However, it is also entirely possible that a fluidic connection exists in the connecting section temperature control circuit on the one hand and the rotor chamber temperature control circuit on the other or that common elements can be used. For example, the same temperature control fluid can be used. Alternatively or cumulatively, it is possible that the same pressure source, in particular a pump or a pressure reservoir, is used to provide the flow of temperature control fluid through the two temperature control circuits.

It is also suggested that there is an electronic control unit comprising control logic that controls (open loop or closed loop) the rotor chamber temperature control power of the rotor chamber temperature control circuit. Here, this electronic control unit can be embodied separate from the control unit of the connecting section temperature control circuit or these can be combined to form one single control unit.

There are many options for designing the rotor chamber temperature control circuit. In one embodiment, a temperature sensor is provided which (directly or indirectly) senses the temperature of a rotor chamber. For example, the temperature sensor can be integrated into a wall of the vessel, into a cover or lid etc. of the continuous flow centrifuge or protrude into the rotor chamber or adjoin the rotor chamber. It is also possible that the temperature sensor is arranged on the rotor and rotates with it. Preferably, the temperature sensor is arranged in a flow-calmed area of the interior of the rotor chamber. The control logic controls the rotor chamber temperature control circuit taking into account a temperature signal from the temperature sensor, preferably by controlling the temperature to a setpoint value. Any control strategy can be used here.

In one embodiment, the control logics for controlling (open loop or closed loop) the rotor chamber temperature control power of the rotor chamber temperature control circuit on the one hand and the connecting section temperature control power of the connecting section temperature control circuit on the other hand are not independent of each other, but are coordinated with each other. This can mean, for example, that an increase in the rotor chamber temperature control power is automatically coupled by the control logic with an increase in the connecting section temperature control power. However, it is also possible that the control logic ensures that the sum of the rotor chamber temperature control power on the one hand and the connecting section temperature control power on the other remains constant, does not fall below and/or exceed a threshold value or corresponds to a characteristic map or curve that is dependent on the operating parameters.

For a special embodiment of the control logic, the control logic takes into account a heating power of the media flowing through the connection conduits for the control (open loop or closed loop) of the connecting section temperature control power. If, for example, the supply and/or discharge of the medium to be centrifuged and/or a residual medium through the connection conduits is switched to a supply of a rinsing or buffer solution, the medium on the one hand and the rinsing or buffer solution on the other hand may comprise different heating capacities. Based on the simplifying assumption (made for explanatory purposes only), that the same heat is absorbed by the media per time, the heat absorption in the medium with the higher heat capacity leads to a smaller temperature change than in the medium with the lower heat capacity. Thus, for the control based on the temperature difference, a different amplification factor of the temperature difference must be taken into account for determining the signal for the control (open loop or closed loop) of the connecting section temperature control power. The same applies to the flow of the media flowing through the connection conduits: If a control is based on the temperature difference in the connection conduits, a smaller heat change is determined for a larger flow than for a lower flow, assuming the same heat input. Under certain circumstances, the rotor speed can also be taken into account in the control (open loop or closed loop) of the connecting section temperature control power, as the flexing work in the connecting section is dependent on the rotor speed.

A further aspect is devoted to the fact that a different heat input occurs at different locations in the connecting section: heat is preferentially generated in the areas in which the flexing work occurs, while non-deformed or non-flexed sections of the connecting section are not heated or are heated to a lesser extent. One embodiment takes this observation into account by designing the connection section temperature control circuit in such a way that a different cooling power is emitted in different sections of the connection section. Only a few non-limiting examples are given below:
For a first variant, this can be achieved by changing the cross sectional area of the temperature control supply conduit and/or the temperature control discharge conduit over the longitudinal extension, which also results in different flow conditions depending on the cross-sectional area and thus different cooling powers.
Alternatively or cumulatively, it is possible that the cross-sectional geometry of the temperature control supply conduit and/or the temperature control discharge conduit varies. It is possible, for example, that in one subsection the cross-sectional geometry is such that a large sheath surface is created, which ensures good heat transfer, while in another subsection the cross-sectional geometry is selected such that a smaller sheath surface is created, resulting in poorer heat transfer.
In this context, it is also possible to branch the temperature control supply conduit and/or the temperature control discharge conduit in those areas where an increased cooling power is required.
For a further alternative or cumulative proposal, the heat transfer coefficient of a wall or sheathing of the temperature control supply conduit and/or the temperature control discharge conduit can be reduced or increased in the different subsections according to the desired cooling power, which can be achieved by using different wall materials and/or sheathing materials and/or different wall thicknesses of the wall and/or sheathing in the subsections.
It is also possible that throttles or other fluidic components that influence the flow behavior conditions are used in subsections.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated geometries and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to the features mentioned in the claims, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described on the basis of preferred embodiments shown in the figures.

FIG. 1 shows a highly schematized three-dimensional representation of a continuous flow centrifuge in a semi-longitudinal section.

FIG. 2 shows a detail II of the continuous flow centrifuge according to FIG. 1.

FIGS. 3 and 4 show different designs of a cross-section of a connecting section of a continuous flow centrifuge according to FIGS. 1 and 2.

FIG. 5 shows a block diagram for the control (open loop or closed loop) of a flow centrifuge.

### DETAILED DESCRIPTION

In the figures, components or features that correspond or are similar are sometimes identified with the same reference signs, whereby these components or features may then be distinguished from one another by the additional letter a, b, . . . . In this case, reference can be made to these components or features with or without the additional letter, whereby one of the components or features or several or all components or features can then be addressed.

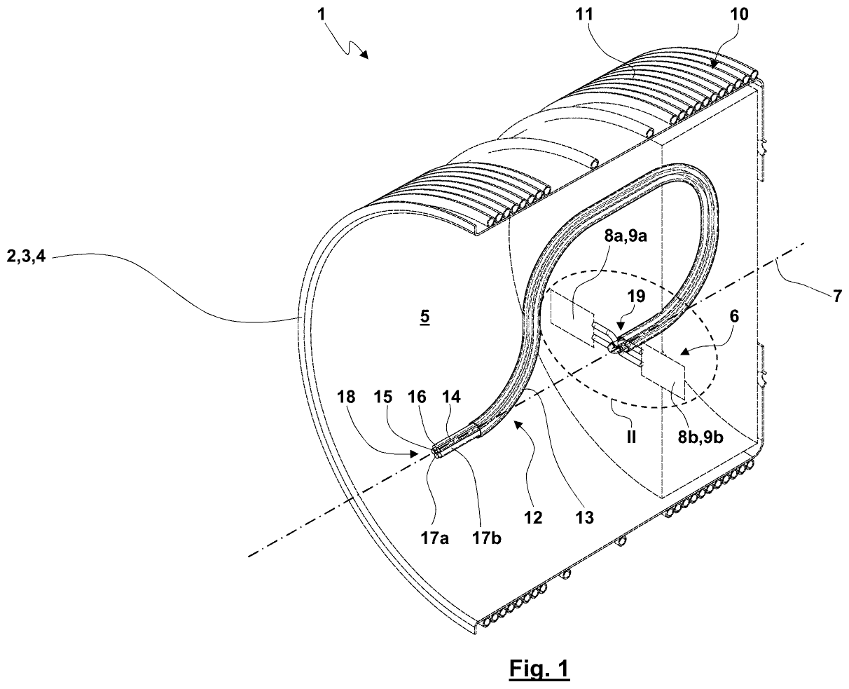

FIG. 1 shows a highly schematic three-dimensional representation of a continuous flow centrifuge 1 in a semi-longitudinal section. The continuous flow centrifuge 1 has a housing 2 and, in particular, a vessel 3 with a wall 4. The wall 4 of the vessel 3 defines a rotor chamber 5 in which a rotor 6 is rotated about a rotor axis 7 at a rotor speed. In the schematic representation according to FIG. 1, only receptacles 8a, 8b of the rotor 6 (here two receptacles 8a, 8b, although any other number of receptacles 8 may also be present) arranged in the centrifugation chamber of the rotor 6 are shown, which may be blood bags 9 or any other receptacles, for example. The receptacles 8 are distributed evenly in the circumferential direction around the rotor axis 7 and are arranged at the same distance from the rotor axis 7.

The continuous flow centrifuge 1 has a rotor chamber temperature control circuit 10, of which only a rotor chamber temperature control loop 11 is shown in FIG. 1. The rotor chamber temperature control loop 11 is integrated into the wall 4 of the vessel 3 and winds with several turns around the rotor axis 7 and the rotor chamber 5.

FIG. 1 also shows a connecting section 12 (connecting strand or umbilical, in the following “connecting section”). The connecting section 12 comprises a flexible hose or a flexible tube 13. A temperature control supply conduit 14, a temperature control discharge conduit 15 (whereby these are also jointly referred to by the term “temperature control conduit”) and two connection conduits 16, 17 extend through the hose or tube 13. There is a flow through these conduits in different directions during the different operating phases of the centrifugation process. In one end region 18, the connecting section 12 is attached to the housing 2 or a wall 4 of the vessel 3, while in another end region 19, the connecting section 12 is attached to the rotor 6 and is rotated with it. The guiding device rotating at half the rotor speed, in particular a guiding tube, is not shown in the schematic FIG. 1 (cf. the state of the art mentioned at the beginning).

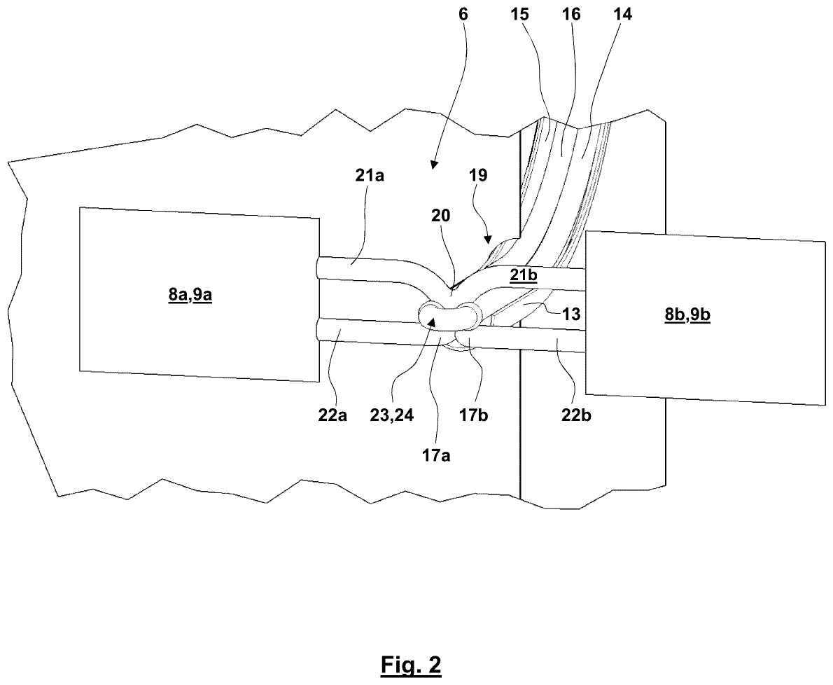

FIG. 2 shows a detail II of FIG. 1. In this detail, the end region 19 of the connecting conduit 12 can be seen as well as the exit of the temperature control conduits 14, 15 from the hose or tube 13 and their connection to the receptacles 8a, 8b. As an optional special feature, it can be seen here that the receptacles 8a, 8b are each connected to individual connection conduits 17a, 17b, through which the medium flows in the same direction, while the receptacles 8a, 8b are connected to a common connection conduit 16 for the flow of the medium in the other direction. If the flow through the connection conduit 17a, 17b can be controlled (open loop or closed loop) individually or differently via a valve or switchover device, a specific and different application of the medium to the receptacles 8a, 8b can be controlled. For example, only a single receptacle 8a, 8b can be filled or centrifuged sediments can be discharged from the receptacles 8a, 8b at different times.

At the exit from the tube or hose 13, the connection conduit 16 is connected via a branching 20 to two connecting conduits 21a, 21b, which are in turn each connected to an associated receptacle 8a, 8b. The connection conduits 17a, 17b are connected directly to the associated receptacle 8a, 8b via associated connecting conduits 22a, 22b. In the area of the transition from the connection conduits 16, 17 to the connection conduits 21, 22 there are angles of 90°, so that the connection conduits 21, 22 extend in a plane transverse to the rotor axis 7.

The temperature control conduits 14, 15 are connected to each other immediately adjacent to the end of the tube or hose 13 via a reversing connection 23, which is embodied as a U-shaped connecting piece 24 in this case. The bends and transition areas between the connecting conduits 16, 17 and the connecting conduits 21, 22 extend through the interior of the U-shaped connecting piece 24. This results in the reversing connection 23 at least partially enclosing at least one connecting conduit 16, 17. The U-shaped connecting piece 24 can also ensure that the bends and the connecting conduits 21, 22 are fixed in position.

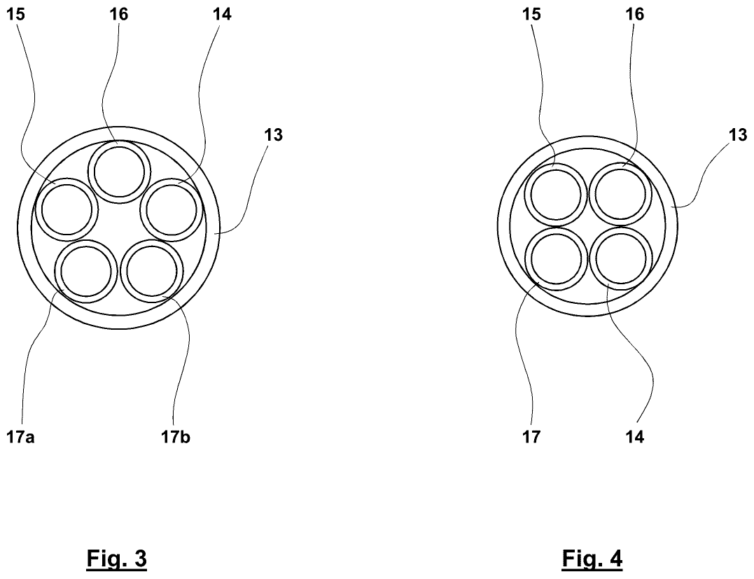

FIG. 3 shows a cross-section of the connecting section 12. It can be seen here that the temperature control conduits 14, 15 and the connection conduits 16, 17a, 17b are arranged distributed on an arc of a circle in the circumferential direction and contact each other directly in the circumferential direction and on the outside contact the inner surface of the tube or hose 13. Here, the order in the circumferential direction is preferably selected such that at least one connection conduit 16, 17 is arranged between the temperature control conduits 14, 15 in both circumferential directions. Thus, the connection conduit 16 is arranged in one circumferential direction between the temperature control conduits 14, 15, while the two connection conduits 17a, 17b are arranged in the other circumferential direction between the temperature control conduits 14, 15.

According to FIG. 4, it is also possible that only four conduits, namely the temperature control conduits 14, 15 and the connection conduits 16, 17, are arranged in the cross-section. In this case, the connection conduits 16, 17 can each comprising a branching to the different receptacles 8a, 8b. It is understood that more than two receptacles 8 can also be present in the rotor 6 via a different design of branchings and/or a different number of conduits and can be supplied with the different media.

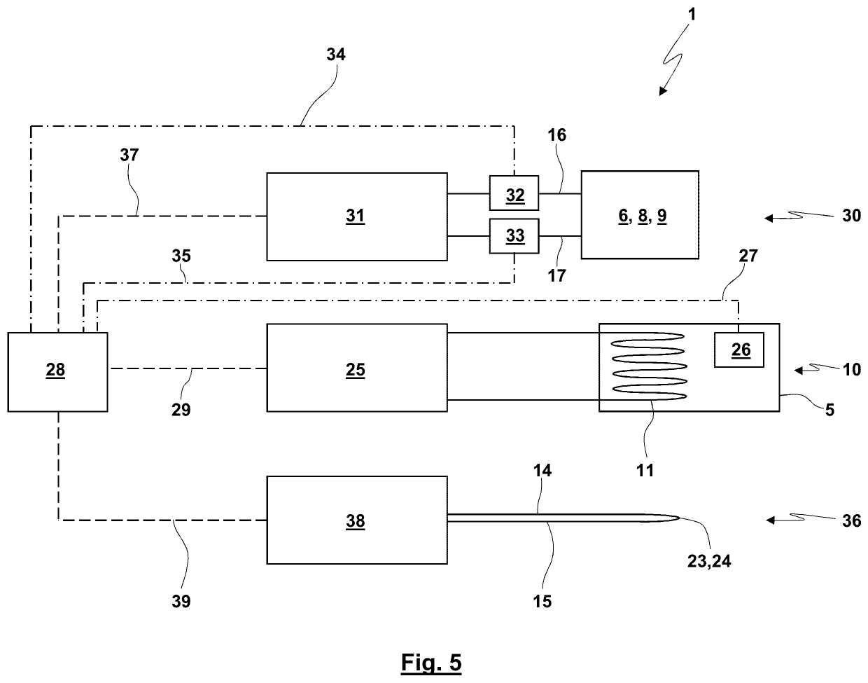

FIG. 5 schematically shows a control device of a continuous flow centrifuge 1:

The rotor chamber temperature control circuit 10 has a supply unit 25 in which the rotor chamber temperature control fluid is provided in a controlled (open loop or closed loop) manner with the required flow and temperature. The rotor chamber temperature control fluid is then supplied to the rotor chamber temperature control loop 11 (which can be integrated into a wall 4 of the rotor chamber 5) in a closed circuit. A temperature sensor 26 detects the temperature in the rotor chamber 5. The temperature sensor 26 is preferably integrated into the wall 4 of the rotor chamber 5 or is held by the wall 4. The measurement signal from the temperature sensor 26 is supplied to an electronic control unit 28 via a sensor signal transmitting connection 27. The control unit 28 has control logic that produces a control (open loop or closed loop) signal in a control line 29 for controlling the supply unit 25 to provide the controlled flow with the controlled temperature of the rotor chamber temperature fluid.

A centrifugation media circuit 30 has a supply unit 31, which provides the different operating phases mentioned at the beginning in the centrifugation media circuit 30 and provides the media, in particular the medium to be centrifuged and a rinsing or buffer solution, with the required flows and flow directions in the different operating phases. A temperature sensor 32, 33 is arranged in each of the end regions 18 of the connection conduits 16, 17 of the centrifugation media circuit 30, which detect the temperature of the media supplied to the centrifugation chamber or the receptacles 8 as well as of the discharged media. The temperature signals of the temperature sensors 32, 33 are transmitted to the control unit 28 via sensor signal transmitting connections 34, 35. The control unit 28 comprises control logic that determines a temperature difference from the temperature signals of the temperature sensors 32, 33, which is used for control purposes (open loop or closed loop) of the connecting section temperature control circuit run 36, as will be explained below. Via a control line 37, the control unit 28 controls (open loop or closed loop) the supply unit 31 to provide the required flows and the different operating phases.

In the connecting section temperature control circuit 36, the connecting section temperature control fluid is provided by means of a supply unit 38. The control unit 28 controls the supply unit 38 via a control line 39 in such a way that the connecting section temperature control fluid circulating in the temperature control conduits 14, 15 provides the desired cooling power. Preferably, the supply unit 38 is controlled by the control unit 28 on the basis of the temperature difference between the temperature signals of the temperature sensors 32, 33.

It should be emphasized that FIG. 5 is only a very schematic representation. Individual components shown separately in FIG. 5 may actually be combined to form one component. This can already be seen from the fact that the connecting section temperature control circuit 36 with the temperature control conduits 14, 15 are shown separately from the rotor chamber 5, although the temperature control conduits 14, 15 extend into the rotor chamber 5. In contrast to FIG. 5, it is possible that the two temperature control circuits 10, 36 are not embodied separately, but rather that there is a fluidic coupling of the two circuits 10, 36. Thus, a single common supply unit can provide the same temperature control fluid for the rotor chamber temperature control circuit 10 and the connecting section temperature control circuit 36. In this case, the flows and temperatures in the two circuits 10, 36 are provided by suitable throttle devices, valves or other fluidic components.

In deviation from the above description and the figures, control in the connecting section temperature control circuit 36 can also be based on a temperature sensor integrated into the connecting section 12.

The described sensor signal transmitting connections 27, 34, 35 can be wired or wireless connections. It is also possible that the sensor signals are provided via a bus system. The same applies to the control lines 29, 37, 39.

In FIG. 5, only one control unit 28 is shown, which here ensures the control (open loop or closed loop) of the rotor chamber temperature control circuit 10, the centrifugation media circuit 30 and the connecting section temperature control circuit 36. It is possible that these objects are performed by several control units, which can then also be interconnected or networked.

The heat generated as a result of the flexing work and thus the cooling power to be provided by the connecting section temperature control circuit can, for example, be a maximum of 50 watts to 200 watts, in particular 0 watts to 150 watts. If the medium to be centrifuged is blood, a threshold temperature value that should not be exceeded can be around 37° C., for example.

If the medium to be centrifuged is conveyed through the connection conduits in one operating phase and a rinsing fluid is conveyed through the connection conduits in another operating phase, the different operating phases can be controlled (open loop or closed loop) differently. In particular, a temperature difference measured in the connection conduits can be processed differently or with different amplification factors.

Many variations and modifications may be made to the preferred embodiments of the invention without departing substantially from the spirit and principles of the invention. All such modifications and variations are intended to be included herein within the scope of the present invention, as defined by the following claims.

We claim:

1. A continuous flow centrifuge comprising
a) a rotor with a centrifugation chamber, the rotor being supported for being rotated about a rotor axis,
b) a drive connected to the rotor for driving the rotor at a rotor speed,
c) a connecting section comprising a first connection conduit, via which a medium can be supplied to the centrifugation chamber during operation of the continuous flow centrifuge when the rotor rotates, and comprising a second connection conduit, via which the medium can be discharged from the centrifugation chamber, wherein one end region of the connecting section is fixed to a housing of the continuous flow centrifuge and the other end region of the connecting section is fixed to the rotor,
d) a guiding device which guides the connecting section and which is rotated about the rotor axis at half the rotor speed,
e) a connecting section temperature control circuit with a temperature control supply conduit and a temperature control discharge conduit which extend through the connecting section, wherein the temperature control supply conduit and the temperature control discharge conduit are flowed through in opposite flow directions by a connecting section temperature control fluid, and
f) at least one electronic control unit which comprises control logic which controls the connecting section temperature control circuit.

2. The continuous flow centrifuge according to claim 1, wherein the temperature control supply conduit, the temperature control discharge conduit and the first and second connection conduits are arranged in a cross-section of the connecting section at locations distributed in a circumferential direction around a longitudinal axis of the connecting section.

3. The continuous flow centrifuge according to claim 2, wherein the temperature control supply conduit, the temperature control discharge conduit and the first and second connection conduits are arranged in a cross-section of the connecting section at locations distributed in the circumferential direction around the longitudinal axis of the connecting section in such a way that in both circumferential directions around the longitudinal axis at least one of the first and second connection conduits is arranged in each case between the temperature control supply conduit and the temperature control discharge conduit.

4. The continuous flow centrifuge according to claim 1, wherein the temperature control supply conduit and the temperature control discharge conduit are connected to one another via a reversing connection.

5. The continuous flow centrifuge according to claim 1, wherein the connecting section comprises a flexible tube or a flexible hose through which the temperature control supply conduit, the temperature control discharge conduit and the first and second connection conduits at least partially extend.

6. The continuous flow centrifuge according to claim 4, wherein the connecting section comprises a flexible tube or a flexible hose through which the temperature control supply conduit, the temperature control discharge conduit and the first and second connection conduits at least partially extend.

7. The continuous flow centrifuge according to claim 6, wherein the reversing connection is arranged in an exit area of the temperature control supply conduit and the temperature control discharge conduit from the flexible tube or hose.

8. The continuous flow centrifuge according to claim 7, wherein the reversing connection is U-shaped and at least partially encloses at least one of the first and second connection conduits.

9. The continuous flow centrifuge according to claim 1, wherein at least one electrical line extends through the connecting section.

10. The continuous flow centrifuge according to claim 1, wherein an open loop or closed loop control of at least one of
a) a temperature of the connecting section temperature control fluid and
b) a flow of the connecting section temperature control fluid
takes into account a temperature of the medium in at least one of the first and second connection conduits.

11. The continuous flow centrifuge according to claim 1, wherein an open loop or closed loop control of at least one of
a) a temperature of the connecting section temperature control fluid and
b) a flow of the connecting section temperature control fluid
takes into account a temperature difference in the first and second connection conduits.

12. The continuous flow centrifuge according to claim 1, wherein a rotor chamber temperature control circuit is provided.

13. The continuous flow centrifuge according to claim 12, wherein at least one electronic control unit is provided which comprises control logic which controls the rotor chamber temperature control circuit.

14. The continuous flow centrifuge according to claim 13, wherein a temperature sensor is provided which senses a temperature in a rotor chamber, and the control logic controls the rotor chamber temperature control circuit taking into account a temperature signal from the temperature sensor.

15. The continuous flow centrifuge according to claim 14, wherein the control logics for
a) the control of the rotor chamber temperature control power of the rotor chamber temperature control circuit and
b) the control of the connecting section temperature control power of the connecting section temperature control circuit
are coordinated with each other.

16. The continuous flow centrifuge according to claim 13, wherein the control logics for
a) the control of the rotor chamber temperature control power of the rotor chamber temperature control circuit and
b) the control of the connecting section temperature control power of the connecting section temperature control circuit
are coordinated with each other.

17. The continuous flow centrifuge according to claim 1, wherein the control logic for controlling the connecting section temperature control power takes into account at least one of
a) a heat capacity of the medium flowing through the first and second connection conduits and
b) a heat capacity of the connecting section temperature control fluid
c) a flow of the medium flowing through the first and second connection conduits and
d) the rotor speed.

18. The continuous flow centrifuge according to claim 1, wherein at least one of
a) a cross-sectional area and
b) a cross-sectional geometry and
c) a heat transfer coefficient of a wall or sheath
is different for the temperature control supply conduit and the temperature control discharge conduit.

19. The continuous flow centrifuge according to claim 1, wherein at least one of
a) a cross-sectional area and
b) a cross-sectional geometry and
c) a heat transfer coefficient of a wall or sheath
varies over the longitudinal extension of the temperature control supply conduit or of the temperature control discharge conduit.
